(19) United States
(12) Patent Application Publication
(10) Pub. No.: US 2010/0169519 A1
(43) Pub. Date: Jul. 1, 2010

(54) Reconfigurable buffer manager

(76) Inventors: Yong Zhang, Hillsboro, OR (US); Michael J. Espig, Newberg, OR (US)

Correspondence Address: INTEL CORPORATION;c/o CPA Global, P.O. BOX 52050, MINNEAPOLIS, MN, 55402, US

(21) Appl. No.: 12/319,100

(22) Filed: Dec. 30, 2008

(51) Int. Cl. G06F 12/02; G06F 13/00; G06F 3/00

(52) U.S. Cl. 710/56; 710/52

(57) ABSTRACT

In some embodiments a reconfigurable buffer manager manages an on-chip memory, and dynamically allocates and/or de-allocates portions of the on-chip memory to and/or from a plurality of functional on-chip blocks. Other embodiments are described and claimed.

### TECHNICAL FIELD

The inventions generally relate to a reconfigurable buffer manager.

### BACKGROUND

A System on Chip (SoC), Platform on Chip (PoC), and/or Network on Chip (NoC) environment, or other similar environment, Intellectual Property (IP) blocks such as a processor, a video encoder and/or decoder, audio encoder and/or decoder, graphics, communication, or other type of block is used to provide a particular type of functionality that is included within the chip. Each of the IP blocks typically has it's own on-die buffer, cache, storage, and/or memory, etc. allocated within the chip. The memory is typically statically defined when the chip is designed. This requires a large statically configured aggregate amount of on-die memory that is included with the chip.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

### DETAILED DESCRIPTION

Some embodiments of the inventions relate to a reconfigurable buffer manager.

In some embodiments a reconfigurable buffer manager manages an on-chip memory, and dynamically allocates and/or de-allocates portions of the on-chip memory to and/or from a plurality of functional on-chip blocks.

In some embodiments a system (for example, a System on Chip, a Platform on Chip, and/or a Network on Chip) includes a plurality of functional on-chip blocks, on-chip memory, and a reconfigurable buffer manager to manage the on-chip memory, and to dynamically allocate and/or de-allocate portions of the on-chip memory to the plurality of functional on-chip blocks.

In some embodiments an on-chip memory is managed. Portions of the on-chip memory are dynamically allocated and/or de-allocated to a plurality of functional on-chip blocks.

In a System on Chip (SoC), Platform on Chip (PoC), and/or Network on Chip (NoC) environment, or other similar environment, Intellectual Property (IP) blocks such as a processor, a video encoder and/or decoder, audio encoder and/or decoder, graphics, communication, or other type of block is used to provide a particular type of functionality that is included within the chip. Each of the IP blocks typically has it's own on-die buffer, cache, storage, and/or memory, etc. allocated within the chip. The memory (buffer) is typically statically defined when the chip is designed. This requires a large statically configured aggregate amount of on-die memory that is included with the chip.

In such an SoC, PoC, NoC and/or other similar environment, IP blocks typically need a certain size of buffer for their operation. The requirement of the size of buffer can vary greatly, for example, with the workload (for example, an MPEG2 video decoder that decodes MPEG2 video with different resolutions), with the configuration (for example, the IP block is shut down as a result of power management operations), and/or with different applications, operations, constraints, etc.

The current approach is to allocate enough memory resources during the architecture definition phase of the chip (for example, of the SoC, PoC, NoC, etc.) This will not cause big issues for IP blocks such as SoC IP blocks targeting fixed functionality. However, for reconfigurable IP blocks, which try to target a wide range of applications and workloads, it may result in lower on-chip memory usage efficiency or lower performance due to a lack of required buffer space. This situation is particularly difficult, for example, in Ultra Mobile SoC blocks which have a tight budget for on-chip memory resources and power consumption. Previous implementations for allocation of on-die memory resources tend to allocate the on-die memory resources to individual IP blocks at design time, or power up a large amount of on-die memory shared across IP blocks regardless of configuration or capacity requirements. According to some embodiments, a large pool of on-die memory is shared and configured in a way that is optimal for the particular IP block that is using that portion of the on-die memory.

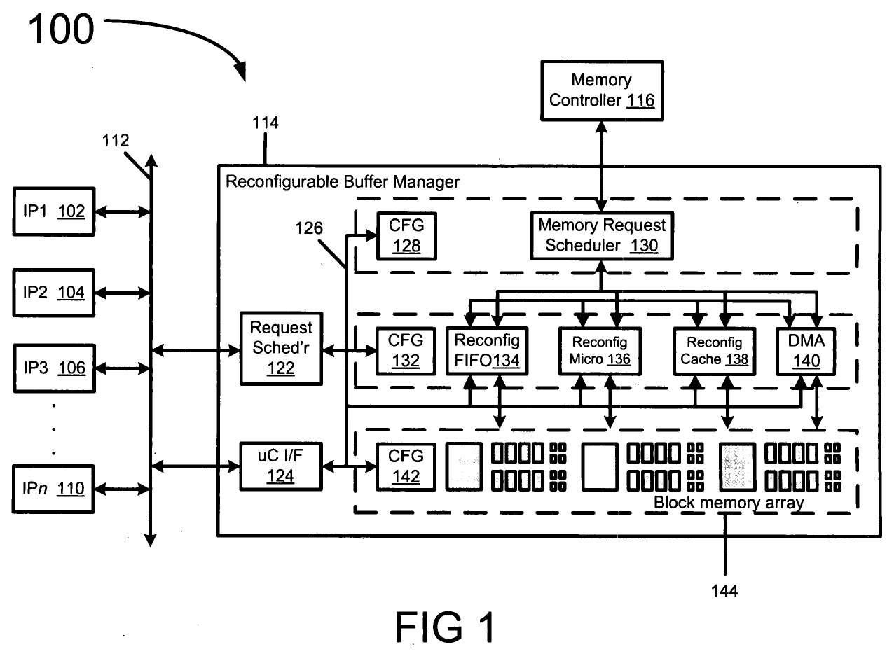

FIG. 1 illustrates a system 100 according to some embodiments. In some embodiments system 100 is a System on Chip (SoC), Platform on Chip (PoC), and/or Network on Chip (NoC) system, or other similar system. In some embodiments, system 100 includes an IP block 1 (102), an IP block 2 (104), an IP block 3 (106), . . . , and an IP block n (110). Any number and type of similar and/or different IP blocks may be included in system 100 according to some embodiments. In some embodiments, each IP block is one or more of a processor, a video encoder and/or decoder, an audio encoder and/or decoder, a graphics unit, a communications unit, a video unit, and/or any other type of block (for example, used to provide a particular type of functionality that is included within the chip). In some embodiments, system 100 further includes a system bus 112 (for example, an SoC system bus, a PoC system bus, an NoC system bus, etc), a reconfigurable buffer manager 114, and a memory controller 116 (for example, in some embodiments a Dynamic Random Access Memory Controller or DRAM controller). In some embodiments, reconfigurable buffer manager 114 includes a request scheduler 122, a microcontroller interface 124, a configuration and PM (power management) bus 126, a configurator 128, a memory request scheduler (for example, a DRAM request scheduler) 130, a configurator 132, a reconfigurable FIFO (first in first out) engine 134, a reconfigurable micro-engine (for example, implementing any type of table lookup) 136, a reconfigurable cache engine 138, a DMA (direct memory access) engine 140, a configurator 142, and a block memory array 144. Although block memory array 144 is illustrated in FIG. 1 as being part of the reconfigurable buffer manager 114, it is noted that in some embodiments the block memory array is not a part of the reconfigurable buffer manager.

In some embodiments, request scheduler 122 receives via system bus 112 the requests from one or more of the IP blocks 102, 104, 106, . . . 110, and buffers and schedules them to a corresponding engine (for example, in some embodiments, a corresponding one or more of engines 134, 136, 138, 140, and/or other engines) for processing. In some embodiments, the microcontroller interface 124 provides an interface for configuration and power management control between system bus 112 and configuration and PM bus 126. In some embodiments, one or more of the IP blocks 102, 103, 106, . . . , 110 is a microcontroller for which the interface 124 is provided for microcontroller interface with bus 126. In some embodiments, the memory request scheduler 130 services memory requests to memory controller 116 from different buffer management engines (for example, from one or more of engines 134, 136, 138, 140, and/or other engines).

In some embodiments, reconfigurable FIFO engine 134 includes hardware state machine logic that services reconfigurable buffer requests configured for the FIFO working mode. Recoverable FIFO engine 134 may be shut down by the microcontroller (for example, one of the IP blocks) when no buffer is configured in the FIFO working mode. In some embodiments, reconfigurable micro engine 136 services complex buffer management requests such as, for example, table lookup, Huffman decoding, and/or other complex buffer management requests. Reconfigurable micro engine 136 may be shut down by the microcontroller when no buffer is configured in the corresponding working mode. In some embodiments, reconfigurable cache engine 138 includes hardware state machine logic that services reconfigurable buffer requests which are configured for a cache working mode. Reconfigurable cache engine 138 may be shut down by the microcontroller when no buffer is configured in the cache working mode. DMA engine 140 enables the bulk data transfer from off-chip memory (for example, such as DRAM) to the on-chip buffer resource. Block memory array 144 is the on-chip memory resource managed by the reconfigurable buffer manager 114. Block memory array 144 may comprise in some embodiments any type of memory (for example, SRAM, DRAM, etc.), and can be distributed into multiple memory sub-blocks (as illustrated in FIG. 1) or into a single memory block. The configurators 128, 132, and 142 may be a configuration table (or tables) and memory that contains the configuration (and reconfiguration) information within the reconfigurable buffer manager 114.

In some embodiments, all or some of system 100 is implemented using hardware architecture which enable IP blocks 102, 104, 106, . . . , 110 (for example, SoC IP blocks, PoC IP blocks, and/or NoC IP blocks) to dynamically allocate and de-allocate on-chip memory resources (for example, block memory array 144, SRAM, and/or DRAM) for better performance and energy efficiency. In some embodiments, dynamic sharing of on-chip memory resources is enabled across IP blocks. This enables better performance and energy efficiency of the IP cores (especially in the case of reconfigurable IP cores) across a wide range of workloads, applications, configurations, etc. In some embodiments, off-chip memory (for example, DRAM) access pattern optimization and active power management commands are enabled to the memory controller for energy efficiency.

Reconfigurable buffer manager 114 can manage a large amount of on-chip memory resources (for example, block memory array 144) which will be shared across IP blocks 102, 104, 106, . . . , 110. At configuration time, the memory resources can be dynamically allocated and de-allocated to the IP blocks. The configuration is performed in some embodiments by the microcontroller or the host processor (which each may be one of the IP blocks). After configuration, the memory resources are made available for use by the corresponding IP blocks.

In order to make it easier for the IP blocks to make use of the reconfigurable buffer resource 144, several working modes are provided by the reconfigurable buffer manager 114. These working modes are configured, for example, during the configuration phase. A group of request commands are defined for each working mode. Exemplary working modes are discussed herein and illustrated in FIG. 1. However, other working modes may be used in various embodiments.

In a FIFO working mode, the allocated buffer is managed as a FIFO memory resource. This may be performed, for example, using reconfigurable FIFO engine 134. The FIFO parameters are set during configuration phase, and the IP blocks will access the FIFO with corresponding request commands. In this manner, the reconfigurable buffer manager 114 is able to service the request and maintain the FIFO internal control states (for example, write pointer, read pointer, etc). FIFO memory resources may be added and/or subtracted as new IP blocks come on-line and/or go off-line.

In a reconfigurable cache working mode, the allocated buffer will be managed as a cache, for example, using reconfigurable cache engine 138. The cache parameters are set during the configuration phase. The IP blocks access the cache with the corresponding request commands. The reconfigurable buffer engine 114 services the request, and maintains the cache internal control states.

In a lookup table working mode, the allocated buffer will be managed as a lookup table, for example, using reconfigurable micro engine 136. The content of the lookup table is initialized during the configuration phase. The IP blocks 102, 104, 106, . . . , 110 perform table lookup operations with the corresponding request command. In some embodiments, examples of table lookup operations include a hash table lookup, a binary tree table lookup, table lookup based computing, and/or Huffman decoding, etc.

In a self-managed buffer working mode, the allocated buffer is managed as a buffer, for example, using DMA engine 140. The IP blocks 102, 104, 106, . . . , 110 manage the usage of the buffer by itself with request commands.

In an off-chip memory access bypassing memory working mode, no buffer is allocated. The reconfigurable buffer manager manages and schedules off-chip memory access requests for optimal energy efficiency.

In some embodiments, other working modes are used. For example, in some embodiments, a user defined working mode is implemented (for example, using reconfigurable buffer manager 114).

In some embodiments, the reconfigurable buffer manager 114 includes a working flow. For example, a working flow of reconfigurable buffer manager 114 includes in some embodiments a configuration phase, a buffer usage phase, and/or a buffer de-allocation phase. In a configuration phase, for example, a microcontroller (such as an on-die processor and/or part of a device driver of an on-die processor) allocates block memory for the internal block, sets up the configuration table, memory etc., and/or assigns a resource identification (ID) to the IP block. In a buffer usage phase, for example, the IP block generates requests to the reconfigurable buffer manager to make use of the on-chip buffer. In a buffer de-allocation phase, for example, the microcontroller de-allocates block memory for the internal block, de-allocates the configuration table, memory, etc., and/or returns a resource ID.

In some embodiments, only the amount of memory (and/or buffer, cache, and/or storage, etc.) that an IP block needs is allocated to that IP block in a dynamic fashion. Sharing of on-chip memory resources is dynamically enabled at configuration to the IP blocks. Better performance and energy efficiency to the IP cores is enabled (particularly for reconfigurable IP cores) across a wide range of workloads, applications, and/or configurations, etc. In some embodiments, memory access pattern optimization and active power management commands are enabled to the memory controller (or controllers) for energy efficiency.

Although some embodiments have been described herein as being implemented in a particular manner or in a particular type of system or with a particular type of memory, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
on-chip memory; and
a reconfigurable buffer manager to manage the on-chip memory, and to dynamically allocate and/or de-allocate portions of the on-chip memory to a plurality of functional on-chip blocks.

2. The apparatus of claim 1, wherein the reconfigurable buffer manager includes a FIFO engine to manage a portion of the on-chip memory.

3. The apparatus of claim 1, wherein the reconfigurable buffer manager includes a reconfigurable cache engine to manage a portion of the on-chip memory.

4. The apparatus of claim 1, wherein the reconfigurable buffer manager includes a reconfigurable micro engine to manage a portion of the on-chip memory.

5. The apparatus of claim 1, wherein the reconfigurable buffer manager includes a lookup table engine to manage a portion of the on-chip memory.

6. The apparatus of claim 1, wherein the reconfigurable buffer manager includes a direct memory access engine to manage a portion of the on-chip memory.

7. The apparatus of claim 1, wherein the reconfigurable buffer manager includes a request scheduler to receive requests from one or more of the functional on-chip blocks and to buffer and schedule the requests to a corresponding engine for processing.

8. The apparatus of claim 1, wherein the reconfigurable buffer manager includes a microcontroller interface for configuration and power management control.

9. The apparatus of claim 1, wherein the reconfigurable buffer manager includes a memory request scheduler to service a request for access to off-chip memory.

10. The apparatus of claim 1, wherein the reconfigurable buffer manager includes a configuration phase, a buffer usage phase, and a buffer de-allocation phase.

11. The apparatus of claim 10, wherein the configuration phase includes an allocation of an internal block, a set up of a configuration table and/or memory, and an assigning of a resource ID, wherein the buffer usage phase includes a receipt of requests at the reconfigurable buffer manager to make use of the on-chip memory, and wherein the buffer de-allocation phase includes a de-allocating of an internal memory block, a de-allocation of a configuration table and/or memory, and a return of a resource ID.

12. A system comprising:
a plurality of functional on-chip blocks;
on-chip memory; and
a reconfigurable buffer manager to manage the on-chip memory, and to dynamically allocate and/or de-allocate portions of the on-chip memory to the plurality of functional on-chip blocks.

13. The system of claim 12, wherein the reconfigurable buffer manager includes a FIFO engine to manage a portion of the on-chip memory.

14. The system of claim 12, wherein the reconfigurable buffer manager includes a reconfigurable cache engine to manage a portion of the on-chip memory.

15. The system of claim 12, wherein the reconfigurable buffer manager includes a reconfigurable micro engine to manage a portion of the on-chip memory.

16. The system of claim 12, wherein the reconfigurable buffer manager includes a lookup table engine to manage a portion of the on-chip memory.

17. The system of claim 12, wherein the reconfigurable buffer manager includes a direct memory access engine to manage a portion of the on-chip memory.

18. The system of claim 12, wherein the reconfigurable buffer manager includes a request scheduler to receive requests from one or more of the functional on-chip blocks and to buffer and schedule the requests to a corresponding engine for processing.

19. The system of claim 12, wherein the reconfigurable buffer manager includes a microcontroller interface for configuration and power management control.

20. The system of claim 12, wherein the reconfigurable buffer manager includes a memory request scheduler to service requests for access to off-chip memory.

21. The system of claim 20, further comprising a memory controller to access the off-chip memory.

22. The system of claim 12, wherein the reconfigurable buffer manager includes a configuration phase, a buffer usage phase, and a buffer de-allocation phase.

23. The system of claim 22, wherein the configuration phase includes an allocation of an internal block, a set up of a configuration table and/or memory, and an assigning of a resource ID, wherein the buffer usage phase includes a receipt of requests at the reconfigurable buffer manager to make use of the on-chip memory, and wherein the buffer de-allocation phase includes a de-allocating of an internal memory block, a de-allocation of a configuration table and/or memory, and a return of a resource ID.

24. The system of claim 12, wherein the system is one or more of a System on Chip, a Platform on Chip, and/or a Network on Chip.

25. A method comprising:
managing an on-chip memory; and
dynamically allocating and/or de-allocating portions of the on-chip memory to a plurality of functional on-chip blocks.

26. The method of claim 25, further comprising a configuration phase, a buffer usage phase, and a buffer de-allocation phase.

27. The method of claim 26, wherein the configuration phase includes an allocation of an internal block, a set up of a configuration table and/or memory, and an assigning of a resource ID, wherein the buffer usage phase includes a receipt of requests at the reconfigurable buffer manager to make use of the on-chip memory, and wherein the buffer de-allocation phase includes a de-allocating of an internal memory block, a de-allocation of a configuration table and/or memory, and a return of a resource ID.
